(19) United States
(12) Patent Application Publication
(10) Pub. No.: US 2002/0184788 A1
(43) Pub. Date: Dec. 12, 2002

(54) Process for drying an object having microstructure and the object obtained by the same

(76) Inventors: Nobuyuki Kawakami, Kobe-shi (JP); Kohei Suzuki, Kobe-shi (JP); Katsuyuki Iljima, Kobe-shi (JP); Takeharu Tanaka, Kobe-shi (JP); Yoshiyuki Nagase, Kobe-shi (JP); Kaoru Masuda, Kobe-shi (JP)

Correspondence Address: REED SMITH LLP, 3110 Fairview Park Drive, Suite 1400, Falls Church, VA, 22042, US

(21) Appl. No.: 10/126,782

(22) Filed: Apr. 22, 2002

(30) Foreign Application Priority Data
Dec. 10, 2001 (JP) 2001-376319
Apr. 24, 2001 (JP) 2001-126618

(51) Int. Cl. F26B 5/06

(52) U.S. Cl. 34/282

(57) ABSTRACT

Disclosed is a drying method constituted such that a microstructure is brought into contact with liquefied carbon dioxide or supercritical carbon dioxide while the surface of the microstructure being covered with a fluorocarbon type solvent, and that when in a cleaning step using a water-containing solvent, water is substituted for a water draining liquid, and then this water draining liquid is substituted for the fluorocarbon type solvent, enabling steps up to the drying step to be smoothly conducted and to prevent collapse or swell of a photoresist pattern.

### BACKGROUND OF THE INVENTION AND RELATED ART STATEMENT

1. Field of the Invention

The present invention relates to a process for drying such an object that has a microstructure and has fine unevenness on its surface as that of a semiconductor substrate. Specifically the invention relates to the process for drying the fine pattern of the object without swell and/or collapse, by employing liquefied carbon dioxide or supercritical carbon dioxide.

2. Description of the Related Art

There is a known process disclosed in JP-A No. 223467/2000 that, when forming a pattern using a photoresist during a semiconductor production process, rinses a substrate after development into alcoholic solvent such as isopropanol (IPA), and dries the same by employing liquefied or supercritical carbon dioxide at low viscosity. The reason for employing the carbon dioxide at a supercritical state having low viscosity for the removal of the rinsing liquid and for drying of the substrate is that an conventional process employing organic solvents involves a problem; upon drying a rinsing liquid, convex portions of the pattern are collapsed due to the capillary force exerted on the gas/liquid boundary or volumic expansion caused by heating upon drying.

Under the circumstances where pattern has been refined to a level of 100 nm or less, aspect ratio of the pattern has been increased rapidly (that has larger height compared with width), and a demand for the dimensional accuracy of the pattern has also become severer gradually than before. Accordingly the conventional process that has steps of rinsing by IPA, then drying by liquefied and/or supercritical carbon dioxide can no longer cope with preventing swell and/or collapse of the fine pattern with such the high aspect ratio.

Further there maybe a case where the substrate is cleaned, not through said steps of rinsing by IPA then drying by liquefied and/or supercritical carbon dioxide, but through the steps of rinsing by super pure water, an aqueous solution containing surfactant or a solvent containing a trace amount of water (referred to as “water-containing solvent”, hereinafter) after the development. So, a method of drying the microstructure cleaned by the water-containing solvent, with no problem of swell and/or collapse of the pattern has also been demanded.

### SUMMARY OF THE INVENTION

In view of the foregoings, this invention aims at providing a drying method with no swell or the like of the pattern upon drying a microstructure such as a semiconductor substrate after the development with liquefied or supercritical carbon dioxide.

According to one aspect of the invention, we provide a method of drying an object having microstructure with liquefied carbon dioxide or supercritical carbon dioxide, wherein the microstructure is in contact with liquefied carbon dioxide or supercritical carbon dioxide, in a state where the surface of the microstructure is covered with a fluorocarbon type solvent. Preprocessing-i.e. rinsing the microstructure with the fluorocarbon type solvent enables swell and the like of the pattern to be suppressed as much as possible.

### DETAILED DESCRIPTION OF THE PREFERRED EMBODIMENTS

Besides the aforementioned gist of the invention, in another preferred embodiment, the drying method sequentially has two steps before the step of covering the surface of the microstructure with a fluorocarbon solvent. The two steps are a step of cleaning the microstructure with a water-containing solvent, and a step of substituting the water on the microstructure for a liquid mixture comprising a fluorocarbon type solvent and a compound having an affinity with the fluorocarbon solvent and also having hydrophilic groups and/or surfactant. Note that the fluorocarbon type solvent which comprises the liquid mixture may be identical/different with/from the fluorocarbon type solvent which covers the surface of the microstructure.

The use of the liquid mixture obtained by dissolving the compound having the affinity with the fluorocarbon type solvent and also having the hydrophilic groups and/or the surfactant into the fluorocarbon type solvent promotes the substitution of the water-containing solvent such as super pure water for the liquid mixture. Further, it also promotes substitution for the fluorocarbon type solvent used in the succeeding rinsing step.

For the compound having the affinity with the fluorocarbon type solvent and also having the hydrophilic groups described above, compounds containing fluorine atoms in the molecule are preferably used. They are highly miscible with the fluorocarbon type solvent and have an excellent effect for suppressing the swell of the pattern.

In another preferred embodiment, a compound having an etheric bond in the molecule is used as an entire portion or a portion of the fluorocarbon type solvent, by which the effect of suppressing the collapse of the pattern is further improved.

In another preferred embodiment, the fluorocarbon type solvent comprises a fluorinated alcohol represented by the general formula: H—(CF₂)ₙ—CH₂OH, which can provide an exellent drying while suppressing the collapse of the pattern. Herein, Symbol n is preferably 2 to 6. This is because the fluorinated alcohol can effectively contact with water on the pattern and can easily be dissolved into carbon dioxide, allowing the fluorinated alcohol to be removed easily. The fluorinated alcohol may also be used being incorporated in liquefied carbon dioxide or supercritical carbon dioxide upon drying by bringing the microstructure into contact with liquefied carbon dioxide or supercritical carbon dioxide. In this case, note that it is not always necessary that the microstructure is covered with the fluorocarbon. It may suffice that the microstructure after the step of cleaning with super pure water is in contact with the liquefied carbon dioxide or supercritical carbon dioxide containing the fluorinated alcohol. Also in this case, a fluorinated alcohol with n of 2 to 6 can be used suitably. When a fluorinated alcohol having with n of 2 to 6 is used, water can be dispersed uniformly in carbon dioxide and drying can be conducted efficiently.

This invention also includes a microstructure obtained by the drying method described above.

The object of the drying method according to this invention is a microstructure, e.g., formed with fine unevenness such as a semiconductor substrate after development of photoresist. Further, this invention is also usable as a drying method for forming a clean dry surface on metals, plastics and ceramics.

The feature of the drying method according to this invention resides in bringing the surface of the microstructure into contact with the liquefied carbon dioxide or supercritical carbon dioxide in a state where the surface of the microstructure is covered with the fluorocarbon type solvent thereby drying the microstructure.

It is considered that since water is scarcely dissolved in the fluorocarbon type solvent, swell of the photoresist material by the incorporation of water can be prevented upon drying by the liquefied or supercritical carbon dioxide. Further, since the fluorocarbon type solvent has a preferred miscibility with the liquefied and/or supercritical carbon dioxide, it can be removed quickly from the surface of the microstructure in the drying step with carbon dioxide. Further, since it is inactive to the photoresist material also in a high pressure state, it has an advantage that the photoresist pattern does not undergo damages.

Specifically, drying is completed as follows. The microstructure, immersed in a fluorocarbon type solvent under an atmospheric pressure, is charged into a chamber capable of applying high pressure treatment in a state where the surface thereof is covered with fluorocarbon type solvent. Then the liquefied carbon dioxide or supercritical carbon dioxide is caused to flow in the chamber, removing the fluorocarbon type solvent from the surface of the microstructure. After that, the chamber is depressurized to thereby cause the liquefied and/or supercritical carbon dioxide to be evaporated from the surface of the microstructure.

The method of covering the surface of the microstructure with the fluorocarbon type solvent includes not only immersion into the fluorocarbon type solvent but also dripping a fluorocarbon type solvent like a shower from above while removing other solvent from the surface by rotating the microstructure in the case where other solvent is deposited to the microstructure for instance.

As the fluorocarbon type solvent, hydrofluoro ethers, hydrofluoro carbons, fluorinated alcohols represented by the general formula: H—(CH₂)ₙ—CH₂OH, and FLUORINATES (registered trademark) manufactured by Sumitomo Three M Co. can be used alone or as a mixture of two or more of them. The hydrofluoro ethers can include, e.g., C₄F₉OCH₃ (e.g., “HFE7100” manufactured by Sumitomo Three M Co.), and C₄F₉OC₂H₅ (e.g., “HFE7200”, manufactured by Sumitomo Three M Co. and the like.

The hydrofluorocarbons include, e.g., CF₃CHFCHFCF₂CF₃ (e.g., “Vertrel” manufactured by DuPont Co.). Further, the FLUORINATE series includes, e.g., “FC-40”, “FC-43”, “FC-70”, “FC-72”, “FC-75”, “FC-77”, “FC-84”, “FC-87”, “FC-3283” and “FC-5312”.

Although the immersion time of the microstructure in the fluorocarbon type solvent has no particular restriction, it may be sufficiently from 10 sec to several minutes. Further, after the development of the photoresist, the microstructure is usually rinsed with a solvent such as isopropanol (IPA) or methyl ethyl ketone to terminate the developing reaction. Also in the method according to this invention, rinsing step with IPA or the like (10 sec to several minutes) may be conducted before the step of immersion to the fluorocarbon type solvent. However, note that since it is not preferred that IPA or the like remains on the surface of the microstructure, it is necessary to completely substitute the surface of the microstructure for the fluorocarbon type solvent.

The liquefied carbon dioxide that can be used for drying in this invention is carbon dioxide pressurized to 5 MPa or more and it may be formed into supercritical carbon dioxide by setting to 31° C. or higher and 7.1 MPa or more. Pressure in the drying step is preferably 5 to 30 MPa and, more preferably, 7.1 to 20 MPa. The temperature is preferably from 31 to 120° C. When it is lower than 31° C., since the fluorocarbon type solvent is less dissolved to carbon dioxide, it takes much time for removing the fluorocarbon type solvent from the surface of the microstructure to lower the efficiency of the drying step. However, even when it exceeds 120° C., no further improved is observed for the drying efficiency and, in addition, it is disadvantageous in view of energy. The time required for drying may be changed optionally in accordance with the dimension of the object or the like and it may be about from several minutes to several tens minutes.

After the completion of the high pressure treatment, since carbon dioxide is rapidly gasified and evaporated by returning the pressure in the chamber to an atmospheric pressure, drying is completed with no destruction of the fine pattern of the microstructure. It is preferred that carbon dioxide in the chamber before depressurization is in a supercritical state. Since it can be depressurized to an atmospheric pressure by way of only the gas phase, pattern collapse can be prevented.

The aforementioned drying method according to this invention is highly suitable to a case of applying drying by liquefied and/or supercritical carbon dioxide after rinsing with IPA after the development. The present inventors have considered applying the invention also to a method of cleaning after development, in which the cleaning is conducted with a water-containing solvent such as super pure water before drying with liquefied and/or supercritical carbon dioxide. However, water and fluorocarbon type solvent are highly immiscible, thus causing a following problem. If the step of covering the surface of the microstructure with the fluorocarbon type solvent is conducted just after the cleaning step, water is left on the surface of the microstructure. This leads to swell and collapse of the pattern. Further, if water is replaced with a liquid mixture formed by the fluorocarbon type solvent mixed with hydrophilic alcoholic solvent (not containing fluorine atom), causing dissolution of the photoresist pattern.

In view of the above, the invention sequentially adds two steps before the step of covering the surface of the microstructure with the fluorocarbon type solvent. The two steps is a step of cleaning the microstructure with a water-containing solvent and a step of substituting the water on the microstructure for a liquid mixture comprising a fluorocarbon type solvent and a compound having an affinity with the fluorocarbon solvent and also having hydrophilic groups and/or surfactant. Note that the fluorocarbon type solvent which comprises the liquid mixture may be identical/different with/from the fluorocarbon type solvent which covers the surface of the microstructure.

The use of the liquid mixture obtained by dissolving the compound (having the affinity with the fluorocarbon type solvent and also having hydrophilic groups) and/or surfactant (collectively referred to as “water draining agent” hereinafter) into the fluorocarbon type solvent-i.e. a liquid mixture having an affinity with both of water and fluorocarbon type solvent (sometimes referred to as “water draining liquid” hereinafter) enables water remaining on the surface of the microstructure to be smoothly substituted for the liquid mixture, thereby removing the water content from the surface of the microstructure. Further, the liquid mixture has a high affinity also with the fluorocarbon type solvent used in the next step of covering the surface of the microstructure with the fluorocarbon type solvent. This allows the step of covering the surface of the microstructure with the fluorocarbon type solvent to be conducted smoothly.

In addition, the water draining liquid produces an advantage that the photoresist is scarcely dissolved or swollen in the water draining liquid, compared with the solution obtained by dissolving an alcoholic solvent, not having fluorine atoms, to the fluorocarbon type solvent. Note that the increase of the amount of the water draining agent in the water draining liquid might cause the photoresist to be dissolved, so that the amount of the water draining agent should be properly controlled. Further the use of a compound, as the fluorocarbon type solvent, having an etheric bond in the molecule (e.g., hydrofluoro ethers described above) or a hydrofluorocarbon (e.g., “Vertrel” manufactured by DuPont Co.), enable the dissolution of the photoresist to be suppressed, although its reason is not apparent at present. Thus, it is preferred to use such fluorocarbon type solvent for the water draining liquid. Note that the fluorocarbon type solvent as the water draining liquid may be identical with or different from that used in the subsequent step.

The water draining agent of the invention affords to employ the compounds having the affinity with the fluorocarbon type solvent and also having hydrophilic groups, and preferably such compounds as having hydrophilic groups, e.g. hydroxyl groups, carboxyl groups and sulfonic groups, and fluorine atoms in the molecule. Specifically, the compounds may include: e.g., fluorine atom-containing alcohols such as trifluoro ethanol and perfluoro isopropanol, fluorinated carboxylic acids in which hydrogen atoms in the alkyl groups of aliphatic carboxylic acids having alkyl group of 4 to 10 carbon atoms such as perfluoro octanoic acid are partially or entirely substituted for fluorine atoms (e.g., “C-5400”, manufactured by Daikin Industry Co., chemical formula: H(CF₂)₄COOH); fluorinated sulfonic acids in which hydrogen atoms in the alkyl groups of aliphatic sulfonic acids having alkyl group of 4 to 10 carbon atoms are partially or entirely substituted with fluorine atoms; and 1-carboxy perfluoro ethylene oxide. Those may be used alone or by mixture.

Preferred combination of the solvent f or the water draining liquid and the water draining agent includes a combination of hydrofluoro ethers or hydrofluorocarbons as the solvent and alcohol having fluorine atoms in the molecule (e.g., perfluoro propanol) or carboxylic acids having fluorine atom in the molecule (fluorinated carboxylic acid).

The amount of the compound having the affinity with the fluorocarbon type solvent is preferably from 0.1 to 10 mass % in the water draining liquid. If it is excessive, dissolution of the photoresist described above may possibly occur. More preferred upper limit is 8 mass %. On the other hand, if it is insufficient, substitution for the water-containing solvent may possibly be insufficient. A more preferred lower limit is 0.5 mass % and further preferable lower limit is 1 mass %.

As the surfactant of the water draining agent, a nonionic surfactant is preferred, and sorbitan fatty acid ester type surfactant is, particularly, preferred since it less dissolves the photoresist. Specific examples available at present for the sorbitan fatty acid ester type surfactant can include, e.g., “RHEODOL SP-300”, “RHEODOL AP-15” and “RHEODOL SP-L11” (trade name of products manufactured by Kao Corp.).

The above-described surfactant is preferably used in an amount of 0.05 mass % or less and, more preferably, 0.02 mass % or less in the water draining liquid, on the ground that it is less soluble to the fluorocarbon type solvent but has high affinity with water, compared with the compound having the affinity with the fluorocarbon type solvent, and that possibly causes dissolution of the photoresist even in a relatively small amount.

There is no particular restriction on the cleaning step by the water-containing solvent and, e.g., a method of immersing the microstructure into the water-containing solvent or a method of dripping a water-containing solvent like a shower while rotating the microstructure can be adopted. The substitution step by water draining liquid may also be conducted by the same manner. Incidentally, the water-containing solvent can include super pure water, pure water, surfactant-containing water and organic solvent in which water (even in a trace amount) is mixed. When the substituent step for the water-containing solvent by the water-draining liquid is completed, the surface of the microstructure is covered with the fluorocarbon type solvent and dried with liquefied and/or supercritical carbon dioxide as described above to complete the drying method of the invention.

### EXPERIMENTS

This invention is to be described more specifically by way of examples but the following examples do not restrict the invention, and any modification within a range not departing the gist to be described later is included within the technical range of the invention. Unless otherwise specified, “parts” means “mass parts” and “%” means “mass %”.

### Experiment 1

Photoresist “ZEP 520” manufactured by Nippon Zeon was spin coated on an Si wafer at a number of rotation of 4000 rpm to form a photoresist film of 3500 Å thickness. Successively, after prebaking at 180° C., patterning was conducted by electron beam exposure. The wafer formed with an exposed photoresist film was immersed in n-amyl acetate and developed for one min. Successively, it was immersed in isopropyl alcohol (IPA) for 30 sec and, further, immersed in hydrofluoro ether (HFE; C₄F₉OCH₃) for 30 sec to completely substitute IPA for HFE.

The wafer was introduced into a chamber capable of high pressure treatment while being kept in a state where the surface was covered with HFE. Carbon dioxide previously heated to 50° C. was pressurized, introduced into the chamber by a liquid supply pump and supercritical carbon dioxide at 7.5 MPa was flown at a rate of 10 ml/min. By the flow of supercritical carbon dioxide, HFE was discharged entirely and inside of the chamber was substituted only for supercritical carbon dioxide. Subsequently, the inner pressure of the chamber was depressurized to an atmospheric pressure while being kept at 50° C., and the wafer having the photoresist film was dried. As a result of observing the photoresist pattern by an scanning electron microscope (SEM) under an electron microscope, collapse of the pattern was not observed at all. Further, the same experiment was conducted while changing 7.5 MPa to 15 MPa. Also in this case, swell of the pattern was not observed at all and it was confirmed that the fine pattern was kept as it was.

### Experiment 2

After the rinsing step by IPA, drying with supercritical carbon dioxide at 7.5 MPa and 15 MPa was conducted in the same manner as in Experiment 1 except for not applying the immersion step by using HFE. When the photoresist pattern was observed by SEM, although the pattern was not collapsed, the width of the photoresist line increased or roughness on the photoresist side wall or the upper portion of the photoresist was increased to confirm that the photoresist itself was swollen. It could also be found that the swell of the photoresist was remarkable in the case at 15 MPa compared with the case at 7.5 MPa.

### Experiment 3

Photoresist “UV2” manufactured by Shiprey Co. was coated at on an Si wafer a number of rotation number of 3000 rpm to form a photoresist film of 4000 Å thickness. Successively, after prebaking at 130° C. for 90 sec, patterning was conducted by electron beam exposure (electron beam acceleration: 50 keV: electron dose 10 μC/cm²). Further, baking was conducted at 140° C. for 90 sec. The wafer formed with the exposed photoresist film was subjected to a developing treatment for one min using a liquid developer (aqueous solution of 2.38% tetramethyl ammonium hydroxide).

After development, super pure water was supplied to the wafer surface while rotating the wafer to or flush away the liquid developer. The water draining liquid shown in Table 1 was supplied while rotating the wafer without drying the wafer surface and super pure water was completely removed from the wafer surface. Successively, a fluorocarbon type solvent “FC-40” (manufactured by Sumitomo Three M Co.) was supplied to the surface while rotating the wafer without drying the wafer surface to completely substitute the water draining liquid for “FC-40”. Rotation of the wafer was stopped and about 10 cc of “FC-40” was additionally supplied to the wafer surface so that the surface was not dried after stopping of the wafer rotation.

The wafer formed with the photoresist film was introduced into a chamber capable of supercritical treatment while being kept in a state where the surface was covered with “FC-40”. While supplying carbon dioxide previously heated to 50° C. by a liquid supply pump to the chamber kept at 50° C., carbon dioxide in the chamber was adjusted to 8 MPa by a pressure control valve, to bring the inside of the chamber into a supercritical state of carbon dioxide. By the flow of the supercritical carbon dioxide through the chamber, “FC-40” was removed out of the chamber to substitute the inside of the chamber only for supercritical carbon dioxide. Subsequently, the pressure in the chamber was depressurized to an atmospheric pressure while maintaining the chamber at 50° C. to dry the wafer having the photoresist film. The photoresist pattern was observed under an electron microscope to observe the absence or presence of pattern collapse or pattern swell. The result of the observation is shown in Table 1. “−” in the table indicates that there were no pattern collapse or pattern swell. “±” in the table indicates the presence of some pattern swell. Further, the water drainability and the photoresist dissolution were evaluated before substituting “FC-40” for supercritical carbon dioxide. For the water drainability, the pattern in a state covered with “FC-40” was observed under an optical microscope to evaluate the absence or presence of water droplets. In the table, water drainability “excellent” indicates that water droplets were not observed at all. Water drainability “Fair” in the table indicates that some water droplets were observed. Photoresist dissolution was evaluated by measuring the thickness of the photoresist film before and after coating the water draining liquid with an ellipsometer. Photoresist dissolution “−” in the table indicates that the thickness did not change.

Each of the water draining agents (that is, perfluoro isopropanol, fluorinated carboxylic acid and trifluoro ethanol) at a concentration not dissolving the photoresist was used in this experiment (that is, 5%, 10% and 1%).

TABLE 1

| Exp. | Water draining liquid | | Water | Photoresist | Pattern | Pattern |
|---|---|---|---|---|---|---|
| No. | Solvent | Water draining agent | drainability | dissolution | collapse | swell |
| 3-1 | HFE7200(95%) | Perfluoro isopropanol(5%) | Exellent | − | − | − |
| 3-2 | HFE7200(90%) | Fluorinated carboxylic | Exellent | − | − | − |
| | | acid(10%) | | | | |
| 3-3 | HFE7200(99%) | Trifluoro ethanol(1%) | Fair | − | − | ± |
| 3-4 | Vertrel | Perfluoro propanol(5%) | Excellent | − | − | − |
| | XF(95%) | | | | | |
| 3-5 | Vertrel | Fluorinated carboxylic | Excellent | − | − | − |
| | XF(90%) | acid(10%) | | | | |
| 3-6 | Vertrel | Trifluoro ethanol(1%) | Fair | − | − | ± |
| | XF(99%) | | | | | |

*HFE7200: C₄F₉OC₂H₅
*Vertrel XF: CF₃CHFCHFCF₂CF₃

### Experiment 4

Development and cleaning step by super pure water after the development were conducted in the same manner as in Experiment 3 and the wafer surface was dried after cleaning merely by a spin drying method. When the photoresist pattern was observed under SEM, fine pattern was entirely collapsed.

### Experiment 5

Photoresist UV2 manufactured by Shiprey Co. was spin coated on the silicon wafer under the number of rotation of 3000 rpm to form a photoresist film of 4000 Å thickness. Successively, after prebaking at 130° C. for 90 sec, patterning was conducted by electron beam exposure. Successively, baking after exposure was conducted at 140° C. for 90 sec and a developing treatment was conducted for one min using a liquid developer (aqueous solution of 2.38% tetramethyl ammonium hydroxide). The liquid developer was flushed away by a method of supplying super pure water to the photoresist surface while rotating the wafer after the development to conduct rinsing.

After rinsing the wafer after the development by super pure water, the super pure water was substituted for a fluorinated alcohol (H—(CF₂)₄—CH₂OH). After substitution, the wafer was introduced into a chamber capable of high pressure treatment in a state where the fluorinated alcohol covered the wafer surface. Subsequently, carbon dioxide heated to 40° C. was supplied by a pump to pressurize the inside of the chamber to 15 MPaG and carbon dioxide was supplied continuously to dry the fluorinated alcohol. After the drying, the pressure was released and the wafer was observed under an electron microscope. It was confirmed that 70 nm line & space, and dot pattern were maintained with no collapse. Further, swell of the photoresist was not observed in each of the pattern.

Further, as a comparative experiment, a sample formed by development and cleaning by super pure water and then drying rapidly by a spin drying method after rinsing not by way of the above-mentioned super critical drying step was also prepared. The sample was observed by SEM. H was observed that 70 nm line & space, and dot pattern were entirely collapsed.

### Experiment 6

Photoresist “UV2” manufactured by Shiprey Co. was spin coated on an Si wafer at a number of rotation of 3000 rpm to form a photoresist film of 4000 Å thickness. Successively, after prebaking at 130° C. for 90 sec, patterning was conducted by electron beam exposure (electron beam acceleration; 50 keV, electron dose: 10 μC/cm²). Further, baking was conducted at 140° C. for 90 sec. The wafer formed with the exposed photoresist film was put to a developing treatment for 1 min by using a liquid developer (aqueous solution of 2.38% tetramethyl ammonium hydroxide).

After the development, super pure water was supplied to the wafer surface while rotating the wafer to flush away the liquid developer. Without drying the wafer surface, a fluorinated alcohol (H—(CF₂)₆—CH₂OH) was supplied while rotating the wafer to completely remove super pure water from the wafer surface and to completely substitute for fluorinated alcohol (H—(CF₂)₆—CH₂OH). After the rotation of the wafer was stopped, additional fluorinated alcohol was supplied by about 10 cc to the wafer surface so that the wafer surface would not dry after the stopping of the wafer.

The wafer formed with the photoresist film was introduced into a chamber capable of supercritical treatment in a state where the surface was covered with the fluorinated alcohol. Then, carbon dioxide previously heated to 50° C., and the pressure of carbon dioxide was controlled to 8 HPa by a control valve to obtain a spercritical state. By flowing the supercritical carbon dioxide through the chamber, the fluorinated alcohol was removed out of the chamber and the inside of the chamber was substituted only by the supercritical carbon dioxide. Subsequently, pressure in the chamber was reduced to an atmospheric pressure while being kept at 50° C., to dry the wafer having the photoresist film. After the drying, the wafer was observed under an electron microscope. It was confirmed that 70 nm line & space and dot pattern were maintained with no collapse. Further, swell of the photoresist was not observed in each of the patterns.

### Experiment 7

Photoresist “UV2” manufactured by Shiprey Co. was spin coated on a silicon wafer at a number of rotation of 3000 rpm to form a photoresist film of 4000 Å thickness. Successively, after prebaking at 130° C. for 90 sec, patterning was conducted by electron beam exposure. Successively, baking after the exposure was conducted at 140° C. for 90 sec, and a developing treatment was conducted for one min using a liquid developer (aqueous solution of 2.38% tetramethyl ammonium hydroxide). After the development, the liquid developer was flushed away by a method of supplying super pure water to the photoresist surface while rotating the wafer after development to conduct rinsing.

After rinsing the wafer after the development with super pure water, the wafer was introduced into the chamber capable of high pressure treatment in a state where the surface was covered with the rinsing liquid. Subsequently, carbon dioxide heated to 40° C. was at first supplied under pressure by a pump to set the inside of the chamber to 15 MPa and 1 mass % of a fluorinated alcohol (H—(CF₂CF₂)—CH₂OH) based on carbon dioxide was supplied together with carbon dioxide to extract the rinsing liquid. After completing the extraction, the supply of the fluorinated alcohol was stopped and only carbon dioxide was supplied thereby extracting the fluorinated alcohol out of the chamber. Subsequently, after the pressure was released, the wafer was observed under an electron microscope. It was confirmed that 70 nm line & space, and dot pattern were maintained with no collapse. Further, swell of the photoresist was not observed in each of the patterns as well.

Further, as a comparative experiment, a sample was also prepared by development and cleaning with super pure water, followed by rapid drying by a spin drying method after rinsing not by way of the supercritical drying step described above. The observation of the awfer by SEM results that 70 nm line & space, and dot pattern were entirely collapsed.

What is claimed is

1. A method of drying a microstructure comprising the steps of:
(1) covering the surface of the microstructure with a fluorocarbon type solvent, and
(2) bringing the microstructure into contact with liquefied carbon dioxide or supercritical carbon dioxide in a state where the surface of the microstructure is covered with the fluorocarbon type solvent.

2. The drying method as defined in claim 1, further comprising, before the step of covering with the fluorocarbon type solvent, the steps of:
(1) cleaning the surface of the microstructure with a water-containing solvent and, after the cleaning step described above,
(2) substituting the water on the microstructure by a liquid mixture of a fluorocarbon type solvent which is identical or different with the fluorocarbon type solvent described above and a compound having an affinity with the fluorocarbon type solvent and also having hydrophilic groups and/or a surfactant.

3. The drying method as defined in claim 2, wherein
the compound having the affinity with the fluorocarbon type solvent and also having hydrophilic groups is a compound containing fluorine atoms.

4. The drying method as defined in claim 1, wherein
the fluorocarbon type solvent includes a fluorocarbon type solvent having an etheric bond in the molecule.

5. The drying method as defined in claim 1, wherein
the fluorocarbon type solvent includes a fluorinated alcohol represented by a general formula: H—(CF₂)ₙ—CH₂OH.

6. The drying method as defined in claim 5, wherein n is 2 to 6.

7. A method of drying a microstructure comprising the following steps of:
(1) bringing the microstructure into contact with liquefied carbon dioxide or supercritical carbon dioxide containing a fluorinated alcohol represented by the general formula: H—(CF₂)ₙ—CH₂OH.

8. The drying method as defined in claim 7, wherein n is 2 to 6.

9. A microstructure obtained by the drying method as defined in claim 1.
